(19) United States
(12) Patent Application Publication
(10) Pub. No.: US 2011/0238925 A1
(43) Pub. Date: Sep. 29, 2011

(54) CACHE CONTROLLER AND METHOD OF OPERATION

(76) Inventor: Dan Robinson, Allen, TX (US)

(21) Appl. No.: 13/122,544

(22) PCT Filed: Oct. 2, 2008
(86) PCT No.: PCT/US08/78605

§ 371 Date: Jun. 20, 2011

(51) Int. Cl. G06F 12/08

(52) U.S. Cl. 711/141; 711/E12.026

(57) ABSTRACT

In one embodiment, there are described a sectored cache system and method of operation. A cache data block comprises separately updatable cache sectors. A common tag block contains metadata for the cache sectors of the data block and is writable as a whole. A pending allocation table (PAT) contains data representing pending writes to the tag block. When writing changes data to the tag block, the changed data is broadcast to the PAT to update data representing other pending writes to the tag block so that when the other pending writes are written to the tag block changed data from received broadcasts is included.

### BACKGROUND

A computer cache typically consists of a data cache, containing copies of data from a larger, slower, and/or more remote main memory, and a tag array, containing information relating to each “line” of data in the data cache. In general, a cache line is the smallest amount of data that can be transferred separately to and from the main memory. The tag data typically contains at least the location in the main memory to which the cache line corresponds, and status data such as the ownership of a cache line in a multi-user system, and a validity state comprising coherency/consistency data such as exclusively owned, shared, modified, or stale. With the large size of some current or proposed computer systems, the size of the main memory address stored in the tag can be very much the largest part of the tag, and can be comparable in size to the data cache line to which it refers.

In some forms of cache, the tag array is stored in faster memory than the data cache. Fast memory is expensive, and to make effective use of its speed must be close to the processor using it, often on the same chip. As a result, there is pressure to maintain a high ratio of data cache size to tag size. However, very large cache lines are inefficient, because they frequently involve moving quantities of data that are not actually wanted.

It has therefore been proposed to use a “sectored cache” or “buddy cache” in which a single tag entry applies to a “block” of the data cache containing several cache lines known as “sectors” or “buddies.” The buddies within a cache block typically correspond to consecutive lines of the main memory, but can be independently owned and have different validity statuses. Thus, for a cache block containing N buddies, the tag entry contains N sets of ownership and validity data, but only one main memory address, resulting in considerable reduction in tag size as compared with N independent cache lines. The performance of the cache (in terms of hit rate and latency) is typically intermediate between N independent cache lines and one cache line N times the size, depending on the usage pattern in a specific use.

Latency is in some situations limited, because in many configurations the tag entry can only be rewritten as a whole, so that a transaction affecting one buddy must be queued pending updating of the tag entry to reflect a transaction affecting another buddy.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of an embodiment of a computer system.

FIG. 2 is a schematic diagram of part of an embodiment of a cache.

FIG. 3 is a block diagram of part of an embodiment of a cache controller forming part of the computer system of FIG. 1.

FIG. 4 is a flowchart of an embodiment of a process of operating a cache controller.

FIG. 5 is a block diagram of part of an embodiment of a cache controller forming part of the computer system of FIG. 1.

FIG. 6 is a flowchart of an embodiment of a process of operating a cache controller.

FIG. 7 is a block diagram of part of an embodiment of a cache device forming part of the computer system of FIG. 1.

FIG. 8 is a flowchart of an embodiment of a process of operating a cache device.

### DETAILED DESCRIPTION

Reference will now be made in detail to various embodiments of the present invention, examples of which are illustrated in the accompanying drawings.

Referring initially to FIG. 1, an embodiment of a computer system indicated generally by the reference numeral 10 comprises a plurality of clients 12, which may be computers comprising processors 14 and other usual devices such as user interfaces, computer readable storage media such as RAM 16 or other volatile memory and disk drives or other non-volatile memory 18, and so on. The clients 12 may be known devices and, in the interests of conciseness, are not described in more detail.

The clients 12 are in communication with one or more servers 20, which comprise main memory 22, which may be a computer readable storage medium in the form of a large amount of volatile memory such as DRAM memory or non-volatile memory containing data that the clients 12 can access. Merely by way of example, the plurality of clients 12 may be in one cell 23 of a multiprocessor computer system, and the server 20 may be in the same or another cell 25 of the same multiprocessor computer system. Accesses from the clients 12 to the server 20 may then pass through nodes 24, 26 connecting their respective cells to a fabric 28 between the cells.

One or more caches may be provided between the client processors 14 and the server memory 22, to reduce the load on the server 20 and speed up access when a client 12 repeatedly accesses the same information from server memory 22. Merely by way of example, a lowest-level (that is to say, furthest from the client processor, and typically largest and slowest) cache 30 in the client cell 23 may be provided at the node 24, and may be shared by the clients 12.

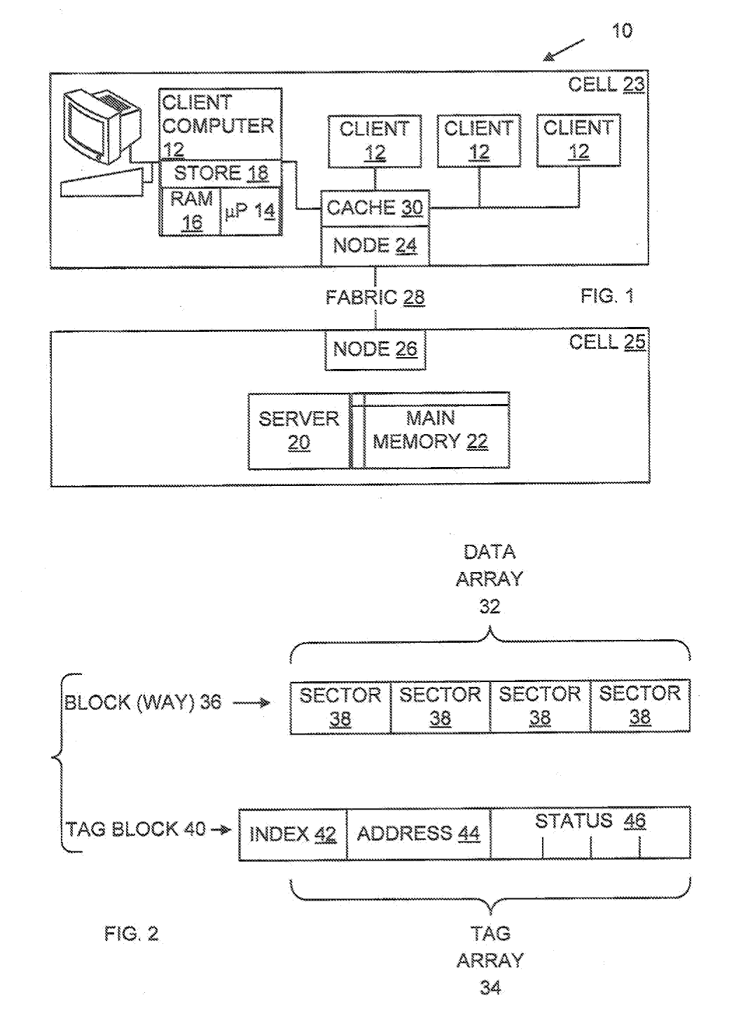

Referring now to FIG. 2, one embodiment of cache 30, which may be used as the cache 30 shown in FIG. 1, is a sectored cache. The cache 30 comprises a data array 32 and a tag array 34. The data array 32 is divided into blocks 36, each of which is divided into sectors 38. In the example shown in FIG. 2, each block has four sectors. The sectors 38 can be read and written independently. The tag array 34 is divided into tag blocks 40, with one tag block 40 for each data block 36. Each tag block 40 comprises an index 42 identifying the block, an address field 44 identifying the block of main memory 22 to which the cache block 36, 40 is assigned, and a set of status sectors 46, one for each data sector 38. The status sectors 46 may record, for example, which client 12 owns each sector 38, whether that sector is exclusively owned, shared, modified or “dirty,” invalid or “stale,” and other relevant information.

The tag array 34 and the data array 32 may be part of the same physical memory device, or different devices. Typically in a sectored cache 30, the tag array 34 is in a smaller but faster memory than the data array 32. In large modern computer systems 10, the length of the main memory address 44 can be comparable to the size of the cache sectors 38, and there can thus be significant savings in having only one main memory address 44 for an entire block 36 of data sectors 38, which can compensate for the loss of flexibility because the sectors 38 within a block 34 must be in a fixed, or at least very concisely describable, relationship, typically consecutive sectors of main memory 22.

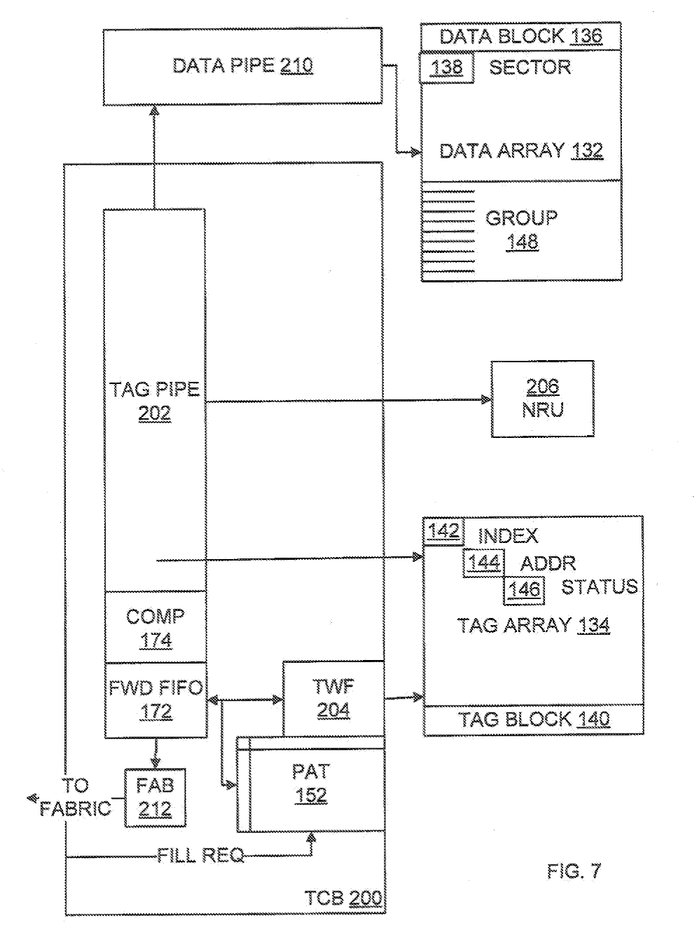

The cache 30 may be a partly associative cache, in which the blocks 36 are grouped, each group of blocks (see group 148. in FIG. 7) is assigned to a particular part of the main memory 22, and any block of data within that part of the main memory 22 may be cached in any block 36 (in this context also called a “way”) in the assigned group. The index entry 42 may then consist of an index for the group 48, and a way value. Where the ways 36 in a group 48 are physically contiguous, space may be saved in the tag array 34 by recording the group index only once for the group 48.

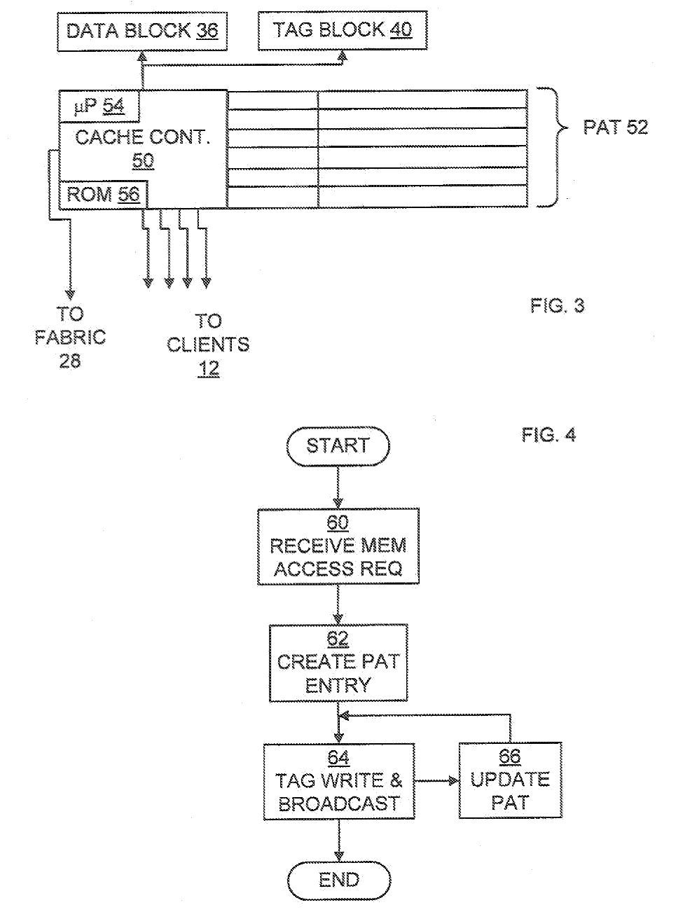

Referring now to FIG. 3, one embodiment of a cache controller 50 that may be used for the cache 30 shown in FIG. 2 comprises a pending allocation table (PAT) 52 containing data representing pending writes to the tag block 40. The writes may be, for example, writes resulting from a cache miss and the subsequent fetching of data from the main memory 22, where there may be a significant delay before the data becomes available. Further, if there are closely timed cache misses, even for the same block, the data may be returned in an order different from the order in which the clients 12 originally dispatched their requests for the data. Further, some status information to be entered in the tag entry 46 may not be available until the data is returned (for example, the server 20 may declare the data to be exclusively owned by the client 12, or shared). It is therefore in many cases advantageous not to finalize the cache tag write until the actual data is available and the cache controller 50 is ready to write the data sector 38 and the tag sector 46.

The cache controller 50 may also comprise a processor 54, and computer readable storage medium 56, such as ROM or a hard disk, containing computer readable instructions to the processor 54 to carry out the functions of the cache controller.

Each entry in the pending allocation table 52 may comprise an identifier for a cache transaction to which it relates, the index of the cache block to which the write is pending, and the contents of the tag block 40 as proposed to be rewritten. For practical reasons, the tag block 40 may be writable only as a whole, so that if two writes are pending at the same time, it would be possible for the second write to reverse or otherwise overwrite the first write.

The cache controller 50 is configured so that, when writing to the tag block 40, the changed data is broadcast to the PAT 52 to update data representing any later pending writes to the tag block. Then, when the later pending writes are written to the tag block 40, changed data that has been received from the broadcasts is included. Thus, the later write refreshes, rather than obliterating, the earlier write.

Referring now to FIG. 4, in an example of a process of using the cache controller 50, in step 60 the cache controller 50 receives a memory access request from a client.

Where the memory access request can be immediately completed, for example, a read request that is a cache hit, it may be processed immediately.

Where the memory access request cannot be immediately completed and would alter a cache tag entry, in step 62 the cache controller 50 creates an entry in the PAT 52 representing the current state of the cache tag entry, by copying the existing entry from the relevant tag block 40. The cache controller 50 may at this time update the PAT entry with as much as is already certain about the proposed tag write, or may not update the PAT entry until a later stage.

In step 64, the cache controller 50 writes a changed entry to the tag block 40, and sends out a broadcast to the PAT specifying the alteration.

In step 66, the cache controller 50 identifies and updates any still pending current PAT entries relating to the same cache tag entry. Then, when in a subsequent iteration of step 62 the other entries are written from the PAT to the tag block 40, the earlier change is included in the later write to the tag block 40, and is confirmed rather than overwritten. This procedure can speed up the second write by several clocks, because it saves the second write having to wait for the first write to complete and then read the current state of tag block 40 before creating its own write.

Where there is more than one cache block, a single PAT 52 may serve all, or a logical group, of the cache blocks. A broadcast is then applied only to pending transactions for the same block to which the broadcast change applied. The PAT 52 may be stored in content addressable memory (CAM), and the index 42 of the cache block 36, 40 to which an entry in the PAT 52 relates may be addressable content.

Each broadcast may contain only the updated data for the specific sector 46 to which the underlying transaction relates, and an identification of that sector. The data can then be substituted in the PAT 52 for the previous data for that sector 46. Where that approach is used, co-pending tag writes for the same sector may be inhibited.

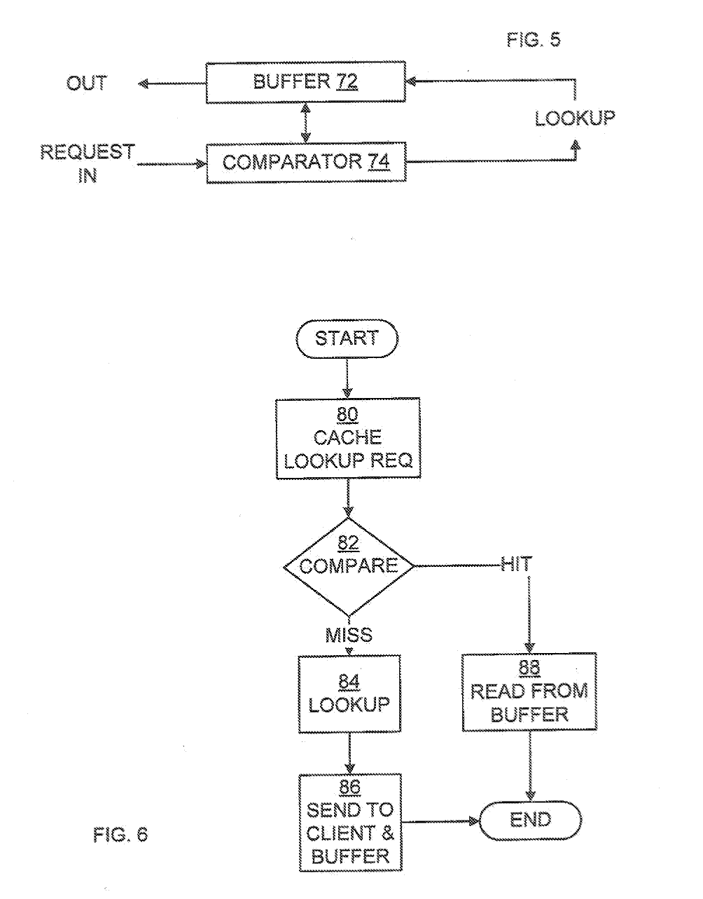

Referring now to FIG. 5, one embodiment of a tag control block 70 that may be used in the cache controller 50 comprises a buffer 72 operative to store cache tag data from recent cache lookups, and a comparator 74 that receives incoming cache lookup requests and compares them with the contents of the buffer 72. When the comparator 74 reports a match, the cache controller 50 supplies the matching information from the buffer 72, instead of processing a new cache lookup.

The buffer 72 may also store currently pending and recently completed cache tag writes.

Where a pending write is supplied from the buffer 72, that can reduce the risk of a client 12 that requests a lookup being supplied with data that is stale before the requesting client has used it, because of the pending write. In the other instances mentioned, time is saved because the second requester does not need to wait for the earlier transaction to complete, and then carry out a tag lookup, which can take several clock cycles. The size of the buffer may be limited so that searching the buffer does not create more delay than it saves, and so as to limit the risk of the buffer itself containing stale data.

Referring to FIG. 6, in one embodiment of a process using buffer 72, in step 80 a client 12 requests a cache lookup. In step 82, the comparator 74 compares the lookup request with the contents of buffer 72. If the comparison fails, in step 84 the lookup is completed. In step 86 the result, which is typically a readout of the data in one or more tag blocks 40, is sent to the requesting client 12, and stored in the buffer 72. As shown by the looping arrow in FIG. 6, steps 80 through 86 may occur an indefinite number of times, gradually populating the buffer 72. The buffer 72 may be a FIFO buffer, so that when it is full the oldest data are automatically discarded as new results arrive.

If the comparison in step 82 succeeds, in step 88 the original cache lookup is voided, and the data from the buffer 72 is supplied to the client 12. In this embodiment the buffer 72 is not, updated in step 88. Where motivations for using the buffer 72 include those mentioned above, it may be more beneficial to allow old transactions to be discarded from the buffer even if they are still being used.

Referring now to FIG. 7, a further embodiment of a tag control block for the cache controller 50 of cache 30 is indicated generally by the reference numeral 200. For ease of cross-reference, features in FIG. 7 that are similar or analogous to features previously described have been given reference numerals greater by 200 than those of the previously described features.

The tag control block 200 includes a tag pipe 202, which contains requests for writes to the tag array 34, and a pending allocation table (PAT) 152, which may be similar in construction and function to the PAT 52 shown in FIG. 3. The tag pipe 202 contains pending transactions involving a tag array 134, which contains tag blocks 140 corresponding to data blocks 136 in a cache data array 132. The data blocks 136 are associated as “ways” within groups 148, and are divided into sectors 138. Each tag block 140 is assigned to a data block 136, and contains an index 142, a main memory 144, and a status sector 146 for each data sector 138 of the corresponding data block 136.

The tag array 132 is so configured that in normal operation individual tag blocks 140 can be written or overwritten, but that parts of a tag block 140 cannot be written or overwritten separately.

The PAT 152 and the tag pipe 202 feed writes into a Tag Write FIFO 204, from which they are actually written to the tag array 134. The tag pipe 202 can also send non-writing cache tag lookup requests directly to the tag array 134, and can update a Not Recently Used register 206, which tracks how recently each cache block 136, 140 has been used, and can identify suitable blocks for replacement by newly-retrieved data. The tag pipe 202 has a forwarding FIFO 172 that contains tag writes waiting to be passed to the tag write FIFO 204, and may also contain recent past tag writes and the results of recent lookup requests. The tag pipe 202 also comprises a comparator 174 that can compare cache tag lookup requests with entries in the forwarding FIFO 172. The tag pipe 202 also coordinates with a data pipe 210 to ensure that writes to the cache data array 132 are properly synchronized with writes to the tag array 134. The tag pipe 202 also communicates with a Fabric Abstraction Block 212 that converts the memory addresses 144 used in the cache tag and elsewhere within the cell 23 into a form that will be meaningful when sent across the fabric 28 to another cell 25.

The Pending Allocation Table 152 contains, in an example, 48 lines and serves the entire tag array 134. Each line contains status bits indicating whether the line is pending, completed, or invalid, the index of the tag block 140 to which it relates (which may be an index for a group 148 and a way 136, 140 within that group), and the proposed text of the tag block 140. The PAT 152 is a content addressable memory in which the index is addressable content.

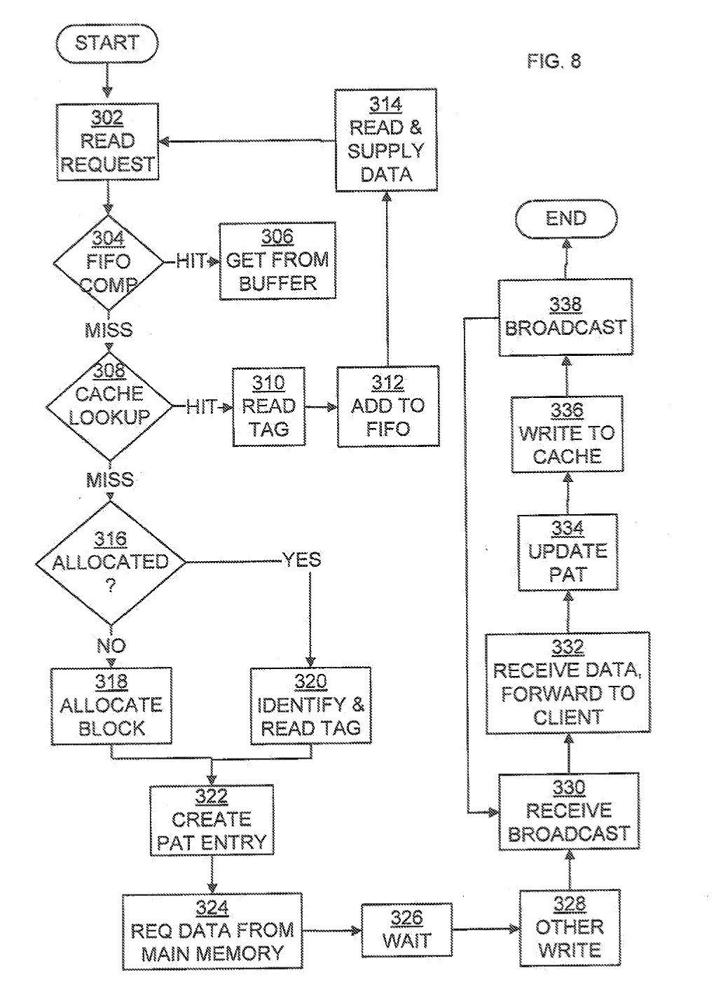

Referring now to FIG. 8, in an embodiment of a method of operating sectored cache, in step 302 a first client 12 dispatches a request to read a sector of data from main memory 22, and that request reaches the cache controller 50. As mentioned above, there may be other levels of cache between the processor 14 of client 10 and cache controller, and the request will typically reach controller 50 only if it misses in any higher level caches.

In step 304, the comparator 174 compares the request with the contents of forwarding FIFO 172. If the comparison returns a hit, in step 306 cache controller 50 retrieves the tag information from FIFO 172. If the comparison failed, in step 308 cache controller 50 does a cache lookup to see whether that sector of data is in cache 132. If there is a cache hit, in step 310 the cache controller 50 reads the tag information from the relevant tag block 140, and in step 312 may add the tag information just read to FIFO 172. In step 314, using the tag data step 306 or 310, the cache controller retrieves the requested data sector from cache 132 and returns it to the requester 12, and updates the NRU register 206 for the cache block in question. The process then returns to step 302 to await the next read request.

If the cache lookup in step 308, returned a miss, in step 316 the process determines whether a cache block has been allocated to the missing data (which may happen if another sector in the same block is already cached). This may be done in the same cache lookup as step 304 and 308, but is shown separately for logical clarity.

If no cache space has been allocated to the memory block in question, in step 318 the process allocates a cache way 136, 140. If all ways in the relevant group are already occupied, the cache controller 50 uses the NRU 206 to eject the least recently used way. The cache controller 50 then configures the tag block 140 to show that block allocated to the block of main memory 22 containing the requested sector of data, but with all sectors in the cache block invalid. If a cache block has been allocated to a data block including the requested sector, in step 320 the process identifies the block and reads the existing tag entry 140. As explained below, the NRU register 206 may be updated at this stage.

/From either step 318 or 320, the process proceeds to step 322, and creates a PAT entry corresponding to the current state of the tag entry 140. if the PAT 152 is full, step 322 overwrites a completed or otherwise invalid line. If every line in the PAT 152 is valid and pending, the new process stalls until a line becomes available.

In step 324, the process sends a request over the fabric 28 to the main memory 22 to provide the missing data. There may be a considerable wait, step 326, before the data is received.

In the case of step 320, where the cache block 136, 140 had already been allocated, there may be an earlier read request for the same block that is still pending. That may be the request that originally caused the block to be allocated, or may be a request for a third sector in the same block. Alternatively, a request for a different sector in the same block may be issued later, but for some reason fulfilled by main memory 22 earlier. In any of those cases, while the process shown in FIG. 7 is waiting at step 326, another write for the same cache block is executed in step 328. Then, in step 330, the cache controller 50 issues a broadcast write to PAT 152. The broadcast is in the form of a CAM write to all lines in PAT 152 that have the same index (including way if that is separately specified) as the transaction to which the broadcast relates, and thus relate to the same cache block 136, 140. The broadcast is thus ignored by PAT lines for other cache blocks. The broadcast identities the sector for the transaction to which the broadcast relates, and gives the new status data 146 for that sector. The new status data is written into the PAT 152, overwriting only the previous status data for the same sector, and thus updating the PAT line without overwriting any data that is not affected by the write being broadcast.

Steps 328 and 330 may happen zero, one, or a plural number of times while step 326 continues to wait.

In step 332, the data requested in step 324 arrives from main memory 22, and is forwarded to the requester 12. In step 334, the data is fed into data pipe 210, and a write request is fed into tag pipe 202. In step 334, the tag data relating to the write are passed from tag pipe 202 to PAT 152, if that has not already been updated, including any status data received from the server 20. For example the server 20 may at this time specify whether user 12 has exclusive or shared ownership of the data sector. As in step 330, the process updates only the tag status sector 146 relating to its own transaction, so that other tag data, including any broadcast updates from step 330, are not affected.

In step 336, the data and the tag data are written to the cache. In the data cache 132, only the new sector 138 is written, but in the tag cache 134 the entire block 140 is written, because that is how the tag cache is constructed. In step 338, the process sends out a CAM write broadcast to the PAT 152, which may become step 330 of another instance of the process, if there is a write to the same tag block 140 still pending.

The PAT line is then marked as completed and invalid, and the process ends.

In the case of a write to cache from a local client 12, for example, a writethrough or writeback of modified data, the write can be added to the pipes 202, 210 immediately, and conflicting transactions can be inhibited or stalled during the short period between the write transaction reading the tag block 140 and writing back the updated tag block 140. Such writes can therefore be completed without using the PAT 152. However, a PAT broadcast (steps 328, 330) is issued when the write takes place, in case there are other transactions pending in the PAT 152 for the same cache block.

Where two cache-miss read requests are received for the same sector, the first request proceeds as shown in FIG. 8 to retrieve the data from main memory 22. The second request is stalled to wait for the first request to retrieve the data. In other situations involving two pending writes to the same sector, the second write is stalled until the first write is completed.

Where a cache block is recalled by server 20 while a write resulting from a cache-miss read is pending, either the transaction is abandoned or (if the server 20 actually supplies the data being recalled) the data may be supplied to the requesting client with an invalid status, but not cached.

Where a cache block is ejected because the cache controller needs more space for a new data block, it is usually undesirable for the ejected block to be one on which a cache-miss read is pending. To reduce the probability of that occurring, the NRU register 206 may be updated at step 318 or 320 to show the block in question as recently used.

Various modifications and variations can be made in the present invention without departing from the spirit or scope of the invention. Thus, it is intended that the present invention cover the modifications and variations of this invention provided they come within the scope of the appended claims and their equivalents.

For example, in FIG. 1 the device managing main memory 22 was described as “server” 20, and the devices 12 were described as “clients.” However, the devices 12 and 20 may be substantially equivalent computers, each of which acts both as server to and as client of the other.

For example, the device 50 has been described as a stand-alone cache controller, but may be part of a one of the other devices in a computing system. The Pending Allocation Table 152 may be several cooperating physical tables, assigned to different clients 12, different parts of cache 30, or in some other way. PAT broadcasts may then be sent only to parts of PAT table 152 to which they are potentially applicable. The cache 30 has been described as a single partially-associative sectored cache, but aspects of the present disclosure may be applied to various other sorts of cache. The skilled reader will understand how the components of computing system 10 may be combined, grouped, or separated differently.

Although various distinct embodiments have been described, the skilled reader will understand how features of different embodiments may be combined.

What is claimed is:

1. A sectored cache system, comprising:
a cache data block comprising separately updatable cache sectors;
a common tag block containing metadata for the cache sectors of the data block and writable as a whole; and
a pending allocation table (PAT) containing data representing pending writes to the tag block;
wherein when writing changes data to the tag block, the changed data is broadcast to the PAT to update data representing other pending writes to the tag block so that when the other pending writes are written to the tag block changed data from received broadcasts is included.

2. A sectored cache system according to claim 1, comprising a plurality of cache blocks and a common pending allocation table operative to contain data representing pending writes to a plurality of said cache blocks from a plurality of clients, wherein a broadcast includes an index identifying a specific cache block and is applied only to pending allocation table entries applying to sectors in that block.

3. A sectored cache system according to claim 1, comprising a content addressable memory containing the common pending allocation table, wherein each entry in the pending allocation table comprises and is addressable by an index identifying the block to which the entry relates, and each broadcast comprises and addresses the common pending allocation table by the index identifying the block to which the broadcast relates.

4. A sectored cache system according to claim 1, wherein a broadcast specifies a sector to which the changed data relates, and is applied to pending allocation table entries for writes updating tag array data relating to other sectors in the same block.

5. A sectored cache system according to claim 1 wherein, when a client dispatches a memory read request that is a cache miss, an entry is created in the pending allocation table before the missing data is fetched.

6. A method of operating sectored cache, comprising:
receiving a memory access request from a client;
where the memory access request cannot be immediately completed and would alter a cache tag entry, creating an entry in a pending allocation table representing the current state of the cache tag entry;
when a cache tag entry is altered, broadcasting the alteration to the pending allocation table and updating pending allocation table entries relating to the same cache tag entry; and
when making an alteration to which a pending allocation table entry relates, basing the alteration on the pending allocation table entry, including any updates from received broadcasts.

7. A method according to claim 6, comprising maintaining a common pending allocation table for entries relating to access requests from a plurality of users to a plurality of cache blocks, each block comprising a plurality of sectors with a common tag entry, and applying a broadcast to entries relating to access requests for different sectors of the same block to which the broadcast relates.

8. A method according to claim 6, wherein an entry in the pending allocation table is updated for the request to which it relates only when the entry is ready to be written to the cache tag.

9. A computer readable storage medium containing instructions for causing a cache controller:
to receive a memory access request from a client;
where the memory access request cannot be immediately completed and would alter a cache tag entry, to create an entry in a pending allocation table representing the current state of the cache tag entry;
when a cache tag entry is altered, to broadcast the alteration to the pending allocation table and to update pending allocation table entries relating to the same cache tag entry; and
when making an alteration to which a pending allocation table entry relates, to base the alteration on the pending allocation table entry, including any updates from received broadcasts.

10. A computer readable storage medium according to claim 9, comprising instructions for causing a cache controller to maintain a common pending allocation table for entries relating to access requests from a plurality of users to a plurality of cache blocks, each block comprising a plurality of sectors with a common tag entry, and to apply a broadcast to entries relating to access requests for different sectors of the same block to which the broadcast relates.

11. A computer readable storage medium according to claim 9, comprising instructions for causing a cache controller to update an entry in the pending allocation table for the request to which it relates only when the entry is ready to be written to the cache tag.

12. A cache system, comprising:
a buffer operative to store cache tag data from recent cache lookups;
a comparator operative to compare a cache lookup request with the contents of the buffer; and
wherein information from the buffer is supplied in response to a cache lookup request where the comparator matches the request to information in the buffer.

13. A cache system according to claim 12, wherein the buffer is operative to store pending or recent cache tag writes.

14. A method of operating a cache system, comprising:
receiving a request from a client for a cache lookup;
comparing the lookup request with the contents of a buffer;
where the comparison fails, completing the lookup, sending the result to the requesting client, and storing the result in the buffer; and
where the comparison succeeds, supplying corresponding data from the buffer to the client.

15. A method according to claim 14, further comprising storing in the buffer pending or recently completed cache tag writes.

16. A method according to claim 14, wherein the buffer is a FIFO buffer, further comprising permitting the oldest entry in the buffer to be discarded when a new entry is added.

17. A computer readable storage medium containing instructions for causing a cache controller:
to receive a request from a client for a cache lookup;
to compare the lookup request with the contents of a buffer;
where the comparison fails, to complete the lookup, to send the result to the requesting client, and to store the result in the buffer; and
where the comparison succeeds, to supply corresponding data from the buffer to the client.

18. A computer readable storage medium according to claim 17, containing instructions for causing a cache controller to store in the buffer pending or recently completed cache tag writes.

19. A computer readable storage medium according to claim 17, containing instructions for causing a cache controller, where the buffer is a FIFO buffer, to permit an oldest entry in the buffer to be discarded when a new entry is added.
